(19) United States
(12) Patent Application Publication
(10) Pub. No.: US 2005/0121472 A1
(43) Pub. Date: Jun. 9, 2005

(54) Valve unit

(76) Inventors: Jacobus Adriaan Wessels, Loevenstoin (ZA); Marius Okkort Vermeulen, Durbanville (ZA); Frank Robert Muller, George (ZA)

Correspondence Address: STITES & HARBISON PLLC, 1199 NORTH FAIRFAX STREET, SUITE 900, ALEXANDRIA, VA, 22314, US

(21) Appl. No.: 10/501,404

(22) PCT Filed: Jan. 9, 2003
(86) PCT No.: PCT/IB03/00026

(30) Foreign Application Priority Data
Jan. 15, 2002 (ZA) 2002/0328

(51) Int. Cl. G01F 11/10

(52) U.S. Cl. 222/362; 222/367

(57) ABSTRACT

The invention discloses a valve unit including a dispenser inlet (30,32) and a dispenser outlet (34). A metering chamber (40, 24) having a predetermined volume and two chamber openings (42, 42) is movably located inside the dispenser in a manner allowing at least one of the chamber openings to be moved between a first position where it is aligned with the dispenser inlet (32) and a second position where it is aligned with the dispenser outlet (43). Furthermore, a control member (26) is movably located inside the metering chamber between the chamber openings and is adapted to selectively close off the dispenser outlet.

### FIELD OF INVENTION

The present invention relates to a valve unit.

More particularly, the present invention relates to a valve unit for dispensing flowable materials.

### BACKGROUND TO INVENTION

It is often desirable to obtain a fixed volume of substance out of a tube or bottle. When working with liquids, a fixed volume can be relatively easily measured off in a syringe or a measuring cup. As an aid in dispensing fixed volumes and in order to reduce the likelihood of spillage, a number of measuring caps have been developed for attachment on a bottle or tube.

One such measuring dispensing cap is shown in U.S. Pat. No. 6,041,979. This cap has a housing for attachment to a container and a spout rotatable relative to the housing. A transfer compartment is defined in the spout for firstly receiving material from the container and thereafter dispensing the material after the container is sealed. However, this dispensing cap and other measuring devices cannot be easily used with pastes, creams, salves or other high viscosity substances, which are not readily flowable, as the devices do not allow pressure to be exerted on the material while in the transfer chamber. Without such pressure application, the paste will not flow out of the transfer chamber.

Another metered liquid squeeze container is shown in U.S. Pat. No. 6,186,367. Although this dispenser allows pressure to be applied to the material within the dispensing chamber, i.e. by squeezing the container, the dispenser still is only able to function with a material of relatively low viscosity. If a high viscosity material is used, the material will not flow back into the container and the measuring function of the cap will not function.

It is an object of the invention to suggest a valve unit, which will assist in overcoming these problems.

### SUMMARY OF INVENTION

According to the invention, a valve unit includes a body; a movable member movably associated with the body; a first passage extending through the body; a second passage extending through the movable member, the movable member being adapted to align the second passage with the first passage; and a control member movably located inside the second passage, the control member being adapted to regulate the filling of and the exhausting of a flowable substance from the second passage through the first passage.

The movable member may be located in a recess in the body.

The recess may be a bore.

The recess may be located centrally within the body.

The body may be cylindrical.

The first passage may extend through the body traversing the recess along its diameter.

The movable member may be a spigot rotatably located in the recess.

The movable member may be provided with a gripping member extending beyond the body for rotation of the movable member.

The movable member may be cylindrical having a diameter substantially similar to the diameter of the recess.

The second passage may extend through the movable member having openings on opposite sides of a diameter of the movable member.

The second passage may have a slightly larger diameter than the first passage.

The control member may be adapted to block off the first passage when moved into contact with the body.

The control member may be a spherical ball.

The control member may have a diameter substantially similar to a diameter of the second passage.

The control member may have a diameter larger than a diameter of the first passage.

The valve unit may include attachment means for attaching the body to a supply of a flowable substance, such as a tube of paste.

The attachment means may be a screw-on or clip-on connection.

The valve unit may include alignment means adapted to align the first and second passages so that they are continuous with each other.

The alignment means may include a groove provided in the body and being adapted to accept a pin extending from the movable member, or vice versa.

The groove may describe a substantially arcuate path parallel to a diameter of the bore.

The groove may extend though substantially 180°.

The alignment means may include a ratchet formation allowing unidirectional rotation of the movable member.

The valve unit may include a cap adapted to be removably attached to the body.

The cap may have a lip adapted to prevent attachment of the cap if the first and second passages are in alignment.

The cap may have a lip adapted to prevent movement of the movable member when the cap is attached to the body.

The valve unit may include a one-way valve associated with the first passage being adapted to reduce retraction of the flowable substance into a container during use.

The second passage may have flexible side walls.

The second passage may be adapted to be partially closed by a blocking member to restrict movement of the control member.

The movable member may include a bypass passage in which no control member is provided and being adapted to allow unrestricted and unmeasured volume of the flowable substance to pass through the first passage.

The valve unit may include a self-closing mechanism being adapted to cause the first and second passages to be unaligned when not in use.

The self-closing mechanism may be a spring loaded cam.

The valve unit may include a counter for indicating a total number of dosages dispensed through the first passage.

Also according to the invention, a valve unit includes a dispenser having a dispenser inlet and a dispenser outlet; a metering chamber, having a predetermined volume and two chamber openings, being movably located inside the dispenser in a manner allowing at least one of the chamber openings to be moved between a first position where it is in alignment with the dispenser inlet and a second position where it is alignment with the dispenser outlet; and a control member movably located inside the metering chamber between the chamber openings and being adapted to selectively close off the dispenser outlet.

Further according to the invention, a method of dispensing a flowable substance includes the steps of expressing a first volume of the substance into a metering chamber; and of exhausting the first volume of substance from the metering chamber while simultaneously expressing a further volume of the substance into the metering chamber.

A control member may be movably located in the metering chamber for separating the first volume from the further volume of substance.

The further volume of substance may forcibly act against the control member to move it within the metering chamber and thereby causing the control member to exhaust the first volume of substance out of the metering chamber.

The valve unit may be used in a number of various applications, for example such as for industrial filling lines for filling tubes or bottles, for measuring and mixing various fluids, for infusion pumps, for attachment to syringes to deliver fixed doses of medication, for drop dispensing, for substituting rotary valves found in mass spectrometers, or for measuring two-part Epoxy adhesives.

### BRIEF DESCRIPTION OF DRAWINGS

The invention will now be described by way of example with reference to the accompanying schematic drawings.

In the drawings there is shown in:

FIG. 1 a perspective view of a first embodiment of a valve unit in accordance with the invention;

FIG. 2 an exploded perspective view of the valve unit shown in FIG. 1;

FIG. 3 a side view of a body of the valve unit seen along arrow III in FIG. 2;

FIG. 4 a plan view of the body of the valve unit seen along arrow IV in FIG. 3;

FIG. 5 a side view of a spigot of the valve unit seen along arrow V in FIG. 2;

FIG. 6 a bottom view of the spigot seen along arrow VI in FIG. 5;

FIG. 7 a plan view of the valve unit shown in FIG. 1, shown joined to a supply of a substance;

FIG. 8 a plan view of the valve unit shown in FIG. 7, shown charged or filled with substance;

FIG. 9 a plan view of the valve unit shown in FIG. 7, shown ready to discharge the substance;

FIG. 10 a plan view of the valve unit shown in FIG. 7, shown after discharging the substance;

FIG. 11 an exploded perspective view of a second embodiment of a valve 20 unit in accordance with the invention;

FIG. 12 an assembled sectional side view of the valve unit shown in FIG. 11;

FIG. 13 an enlarged detail of the area indicated by arrow XIII in FIG. 12;

FIG. 14 an assembled view of the valve unit shown in FIG. 13 provided with a one-way valve;

FIG. 15 on an enlarged scale, a sectional view of a third embodiment of a valve unit in accordance with the invention showing a variable dosage passage;

FIG. 16 a side view of a fourth embodiment of a valve unit in accordance with the invention;

FIG. 17 a sectional plan view seen along arrows XVII-XVII in FIG. 16; and

FIG. 18 a sectional side view seen along arrows XVIII-XVIII in FIG. 16.

### DETAILED DESCRIPTION OF DRAWINGS

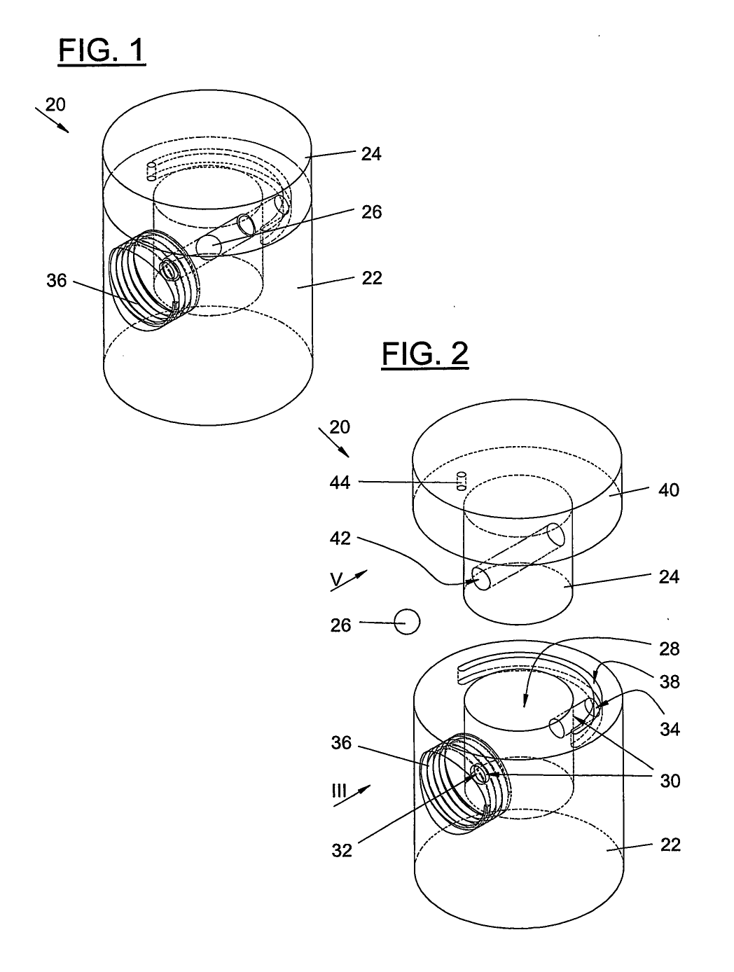

Referring to FIGS. 1 and 2, a first embodiment of a valve unit in accordance with the invention, generally indicated by reference numeral 20, is shown. The valve unit 20 includes a body 22, a spigot 24 movably joined to the body 22, and a control member in the form of a ball 26 movably associated with the spigot 24.

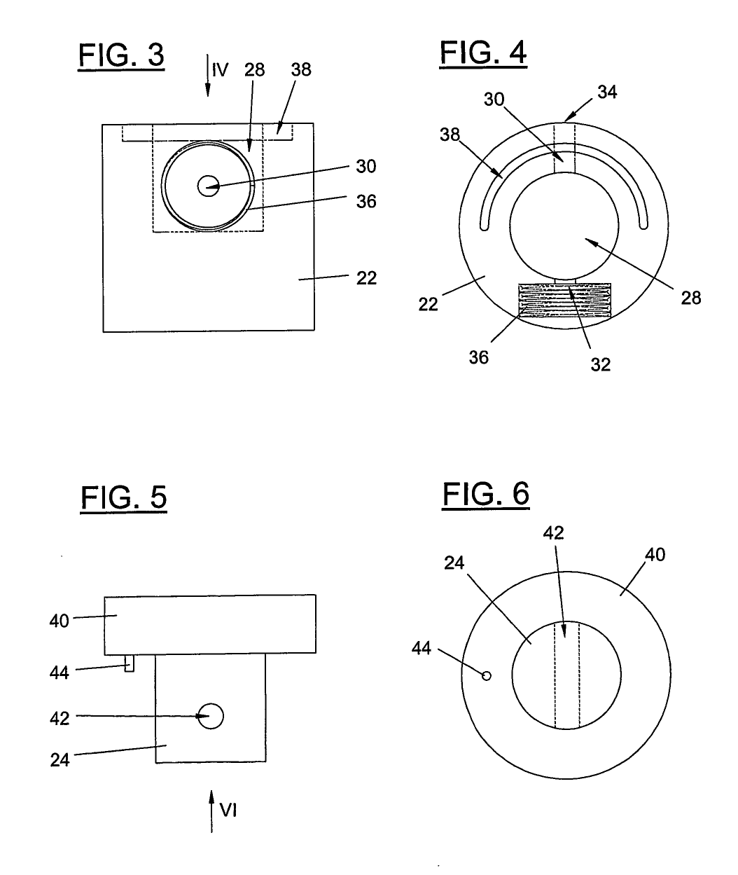

As shown in FIGS. 3 and 4, the body 22 is cylindrical in shape and defines a centrally located cylindrical bore 28. A first passage 30, having an inlet 32 and an outlet 34, extends through the body 22 traversing the bore 28 along a diameter of the bore 28. An internal screw thread 36 is provided in the passage 30 extending from the inlet 32 for joining the valve unit 20 to a supply source during use. The body 22 further is provided with an arcuate guide groove 38, which extends through substantially 180°.

Referring now to FIGS. 5 and 6, the spigot 24 has a diameter substantially similar to the diameter of the bore 28 and is rotatably located therein. The spigot 24 has an outward flange 40 at its end protruding from the bore 28. A second passage 42 extends through the spigot 24, the second passage 42 having openings on opposite sides of a diameter of the spigot 24. This allows the second passage 42 to be aligned with the first passage 30. The diameter of the second passage 42 is slightly larger than the diameter of the first passage 30. A pin 44 extends from the flange 40 into the groove 38.

The control member 26 is a spherical ball having a diameter substantially similar to a diameter of the second passage 42 and larger than a diameter of the first passage 30.

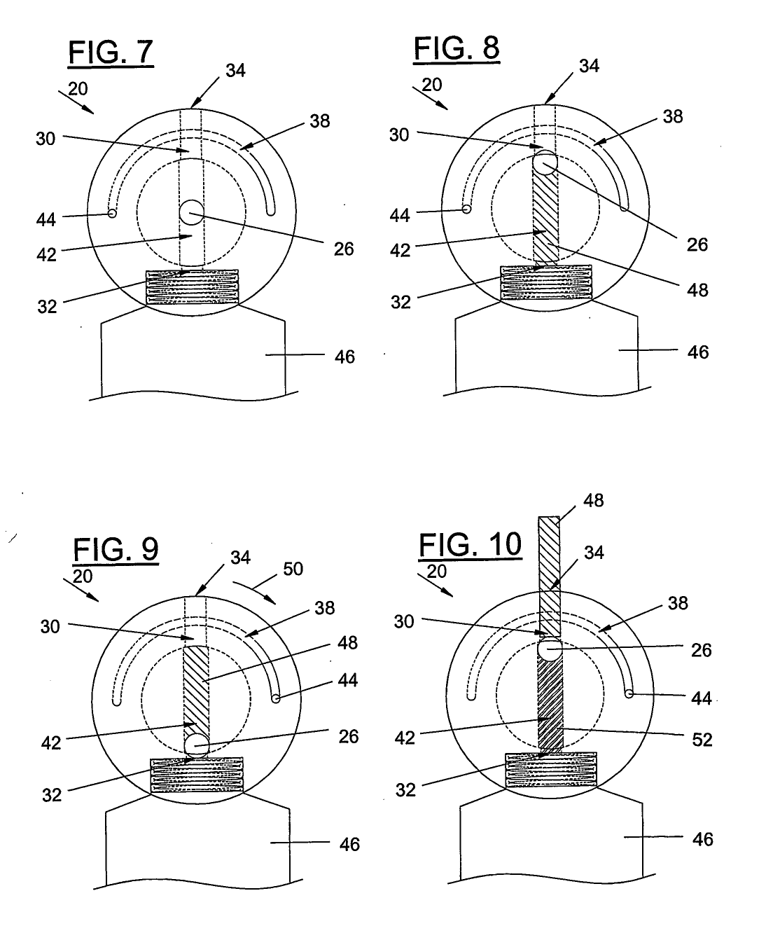

Referring now to FIGS. 7 to 10, in use, the valve unit 20 is joined to supply source, such as a tube 46 of paste. The spigot 24 is rotated so that the first and second passages 30,42 are in alignment, i.e. when the pin 44 is at one end of the groove 38 (as shown in FIG. 7). By pressing the tube 46, a first volume of paste 48 is expressed into the second passage 42 of the valve unit 20 (as shown in FIG. 8). Once the second passage 42 is filled with the paste 48, the ball 26 abuts against the body 22 near the outlet 34. This closes off the first passage 30 and prevents further paste 48 from being expressed from the tube 46.

As shown in FIG. 9, the spigot 24 is rotated relative to the body 22 in the direction of arrow 50 until the first and second passages 30,42 are again aligned, i.e. with the pin 44 being located at an opposite end of the groove 38. The ball 26 thus abuts against the body 22 near to the inlet 32 of the first passage 30.

Finally, the first volume of paste 48 is exhausted from the valve unit 20 by expressing a further volume of paste 52 into the valve unit 20. As the second volume of paste 52 enters the second passage 42, it moves the ball 26 until it again abuts against the body 22 near the outlet 34. Simultaneously, the ball 26 acts to exhaust the first volume of paste 48 from the second passage 42.

Additional volumes of paste can be obtained by repeating the above steps as often as required.

The volume of paste remaining in the first passage 30 can be reduced by shortening its length, e.g. by cutting away a part of the body 22.

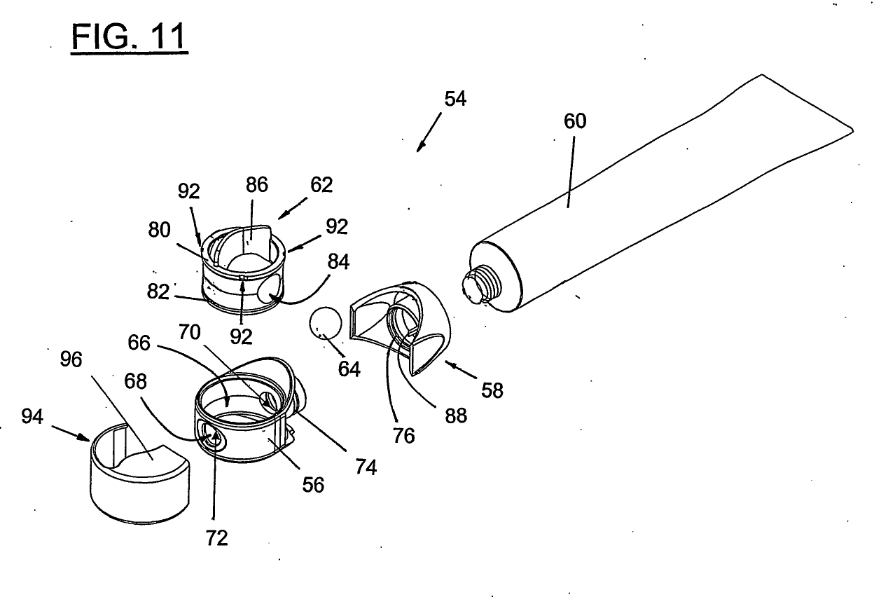

Referring now to FIGS. 11 to 13, a second embodiment of a valve unit in accordance with the invention, generally indicated by reference numeral 54, is shown. The valve unit 54 includes a first body member 56 connectable to a second body member 58, which second body member 58 is adapted to be joined to a tube 60 of paste. A spigot 62 is movably located within the first body member 56, and a control member in the form of a ball 64 is movably associated with the spigot 62.

The first body member 56 is cylindrical in shape and defines a centrally located 1.5 cylindrical bore 66. A first passage 68, having an inlet 70 and an outlet 72, extends through the first body member 56 traversing the bore 66 along its diameter. The first body member 56 and the second body member 58 are attachable by clip engagement of a groove 74 and an annular ridge 76 respectively provided on the two member 56,58.

The second body member 58 has an internal screw thread 78 for attachment to the tube 60 during use.

The spigot 62 is cylindrical in shape having an external diameter which is substantially similar to the diameter of the bore 66, with the spigot 62 being rotatably located within the bore 66. The spigot 62 has two oppositely located outward flanges 80,82 along its outer circular edges for locating the spigot 62 within the bore 66. A second passage 84, which has a diameter slightly larger than the diameter of the first passage 68, extends through the spigot 62, the second passage 84 having openings on opposite sides of a diameter of the spigot 62. Thus, when the spigot 62 is located in the bore 66, the second passage 84 can be aligned with the first passage 68 by suitably rotating the spigot 62. Sealing rings, such as O-rings (not shown), are provided adjacent the flanges 80,82 and around the openings of the second passage 84 to reduce leakage during use.

A protruding gripping member 86 extends from the spigot 62 to enable easy rotation of the spigot 66 inside the bore 66.

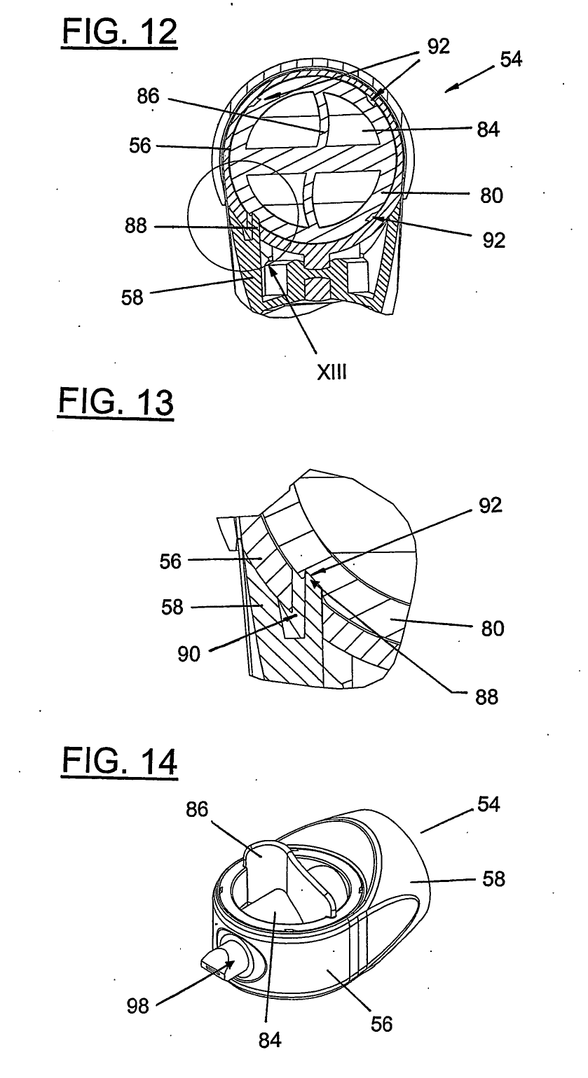

A tongue 88 extends from the second body member 58 through a slot 90 in the first body member 56 and contacts against the spigot 62. The flange 80 of the spigot 62 has a number of spaced apart cut-outs 92, which cooperate with the tongue 88 to form a ratchet allowing unidirectional rotation of the spigot 62. The ratchet interaction between the cut-outs 92 and the tongue 88, which is more clearly shown in FIGS. 12 and 13, also assist in aligning the first and second passages 68,84 during use.

The control member 64 is a spherical ball having a diameter substantially similar to a diameter of the second passage 84 and larger than a diameter of the first passage 68.

A cap 94 is adapted to be removably placed over the valve unit 54. The cap 94 has a lip 96 which allows the cap 94 to be attached to the valve unit 54 only once the spigot 62 has been turned so that the first and second passages 68,84 are transversely positioned relative to each other, i.e. closing the valve unit. The lip 96 also prevents rotation of the spigot 62 while the cap 94 is attached.

In use, the valve unit 54 is joined to the tube 60 of paste. After removal of the cap 94, the spigot 62 is rotated so that the first and second passages 68,84 are in alignment and the tongue 88 engages into a cut-out 92. By pressing the tube 60, a first volume of paste is expressed into the second passage 84, similar to FIG. 8. Once the second passage 84 is filled with the paste, the ball 64 abuts against the first body member 56 near the outlet 72. This closes off the first passage 68 and prevents further paste from being expressed from the tube 60.

The spigot 62 is then rotated through 180° (two ratchets) until the first and second passages 68,84 are again aligned. The ball 64 thus abuts against the first body member 56 near to the inlet 70 of the first passage 68.

Finally, the first volume of paste is exhausted from the valve unit 54 by simultaneously expressing a further volume of paste into the second passage 84, similar to FIG. 10. As the second volume of paste enters the second passage 84, it moves the ball 64 until it again abuts against the body 56 near the outlet 72. The ball 64 thus acts to exhaust the first volume of paste from the second passage 68.

Additional volumes of paste can be obtained by repeating the above steps as often as required.

As shown in FIG. 14, the valve unit 54 can be provided with a one-way valve 98. Although the one-way valve 98 is shown at the outlet 72 of the first passage 68, it can also be equally effectively be located at the inlet 70. The one-way valve 98 prevents the paste, or possibly air, from being retracted into the tube 60 when pressure is released therefrom, e.g. when a partial vacuum is created inside the tube 60 by the resiliency of the tube 60 returning to its original shape.

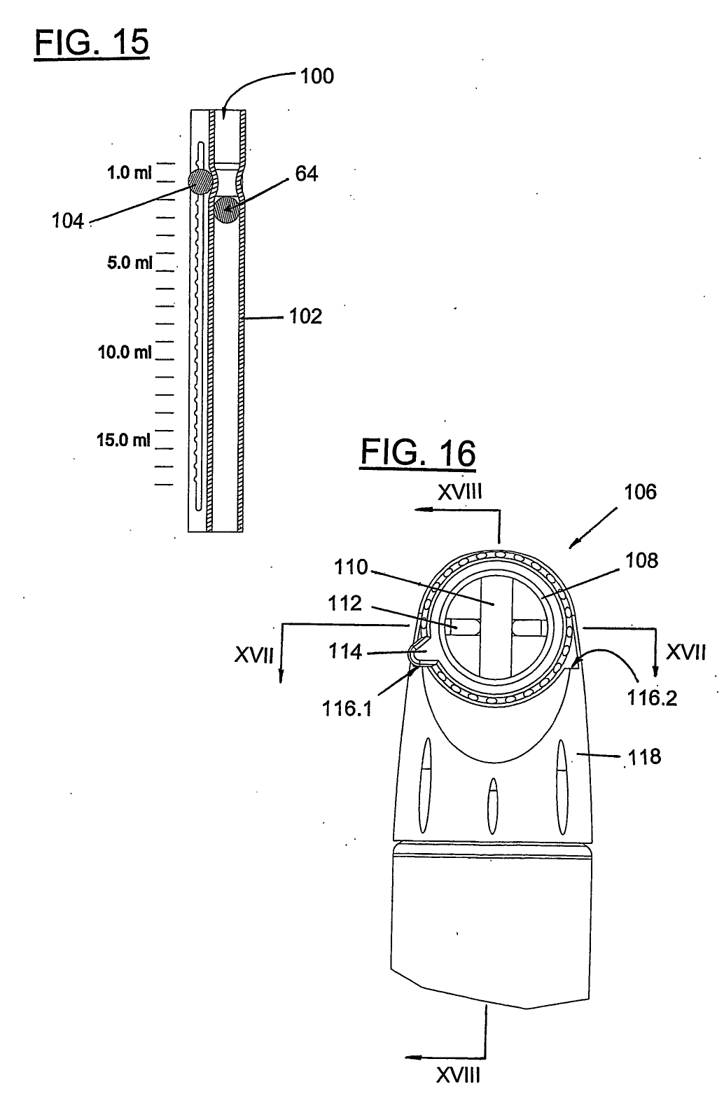

Referring no to FIG. 15, a the valve unit 54 can include a spigot 62 provided with a second passage 100 having flexible side walls 102. Thus by providing a blocking member 104, which partially restricts the second passage 100 and past which the control member 64 is not able to move, the effective volume of the second passage 100 can be altered. By providing discrete positions in which the blocking member 104 can be located, various fixed volumes of the second passage 100 can be obtained, i.e. 1 ml, 5 ml, 10 ml or 15 ml as shown in FIG. 15.

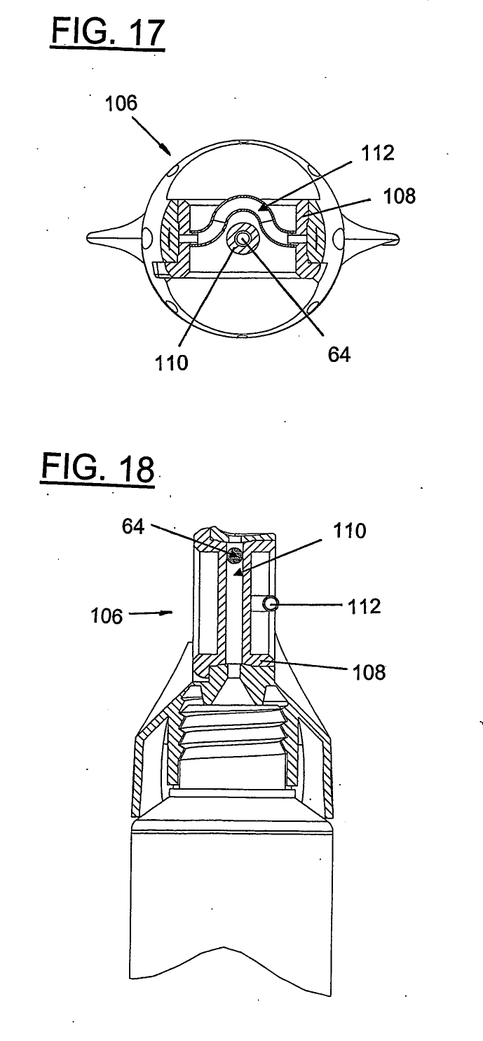

As shown in FIGS. 16 to 18, a fourth embodiment of a valve unit in accordance with the invention, generally indicated by reference numeral 106, is shown. The valve unit 106 includes a spigot 108 provided with two passages 110,112. The passage 110 is substantially similar to the second passage 84, shown in FIGS. 11 to 14, which includes a control member 64. However, the passage 112 is a type of purge passage, in which no control member 64 is provided, thus allowing unrestricted amounts of paste to pass through the valve unit 106.

Also shown in FIG. 16 is a stopper 114, which is integrally formed with the spigot 108. The stopper 114 is adapted to abut against one of two stop faces 116.1,116.2 provided in the body 118 and assists in aligning the respective first and second passages.

It is envisioned that the first and second body members 56,58 can be integrally formed with each other in a single body member.

The valve unit 20 can be manufactured by injection moulding from plastics material.

The control member 26,64 can have any shape suitable for closing off the outlet 34,72. The control members 26,64 can be solid or hollow and can be made of plastics material, such as polystyrene.

The valve unit 20,54,106 can be self-closing wherein the spigot 24,62,108 automatically rotates so that the first passages 30,68 are unaligned with the second passages 42,84,100,110,112 when the valve unit is not in use. This self-closing feature can include a spring loaded mechanism or a cam mechanism.

The valve unit 20,54,106 can include a counter for indicating the total number of dosages dispensed form the tube 46,60.

In each of the embodiments described above, it should be noted that the second passages 42,84,100,110,112 need not be straight but can have any other suitable shape for defining an area within the spigot 24,62,108.

1. A valve unit including a body; a first passage extending through the body, the first passage having an inlet opening and an outlet opening; a movable member rotatably provided in the first passage between the inlet opening and the outlet opening; a second passage extending through the movable member, the movable member being adapted to be rotatable within the first passage to selectively inversely align the second passage with the first passage; a control member movably located inside the second passage, the control member being adapted to regulate the filling of a first volume of flowable substance through the inlet opening into the second passage and, after rotation of the movable member to invert the second passage relative to the first passage, to regulate the exhaustion of the first volume of flowable substance from the second passage through the outlet opening, while simultaneously regulating the intake of a second volume of flowable substance through the inlet opening into the second passage; and alignment means associated with the movable member for aligning the second passage with the first passage so that they are continuous with each other, wherein the alignment means includes a ratchet formation allowing unidirectional rotation of the movable member.

2. A valve unit including a body; a first passage extending through the body, the first passage having an inlet opening and an outlet opening; a movable member rotatably provided in the first passage between the inlet opening and the outlet opening; a second passage extending through the movable member, the movable member being adapted to be rotatable within the first passage to selectively inversely align the second passage with the first passage; a control member movably located inside the second passage, the control member being adapted to regulate the filling of a first volume of flowable substance through the inlet opening into the second passage and, after rotation of the movable member to invert the second passage relative to the first passage, to regulate the exhaustion of the first volume of flowable substance from the second passage through the outlet opening, while simultaneously regulating the intake of a second volume of flowable substance through the inlet opening into the second passage; and a cap adapted to be removably attached to the body, wherein the cap has a lip adapted to prevent attachment of the cap if the first and second passages are in alignment.

3. A valve unit as claimed in claim 2, in which the cap has a lip adapted to prevent movement of the movable member when the cap is attached to the body.

4. A valve unit including a body; a first passage extending through the body, the first passage having an inlet opening and an outlet opening; a movable member rotatably provided in the first passage between the inlet opening and the outlet opening; a second passage extending through the movable member, the movable member being adapted to be rotatable within the first passage to selectively inversely align the second passage with the first passage; a control member movably located inside the second passage, the control member being adapted to regulate the filling of a first volume of flowable substance through the inlet opening into the second passage and, after rotation of the movable member to invert the second passage relative to the first passage, to regulate the exhaustion of the first volume of flowable substance from the second passage through the outlet opening, while simultaneously regulating the intake of a second volume of flowable substance through the inlet opening into the second passage; and a one-way valve associated with the first passage and being adapted to reduce retraction of the flowable substance from the second passage through the inlet opening into a container during use.

5. A valve unit including a body; a first passage extending through the body, the first passage having an inlet opening and an outlet opening; a movable member rotatably provided in the first passage between the inlet opening and the outlet opening; a second passage extending through the movable member, the movable member being adapted to be rotatable within the first passage to selectively inversely align the second passage with the first passage; a control member movably located inside the second passage, the control member being adapted to regulate the filling of a first volume of flowable substance through the inlet opening into the second passage and, after rotation of the movable member to invert the second passage relative to the first passage, to regulate the exhaustion of the first volume of flowable substance from the second passage through the outlet opening, while simultaneously regulating the intake of a second volume of flowable substance through the inlet opening into the second passage; and the second passage having flexible side walls.

6. A valve unit as claimed in claim 5, which includes a blocking member associated with the second passage, the blocking member being adapted to restrict movement of the control member within the second passage.

7. A valve unit as claimed in claim 6, in which the blocking member is adapted to at least partially constrict the side walls of the second passage.

8. A valve unit as claimed in claim 6, in which the blocking member is movable relative to the second passage for changing volumes of the second passage.

9. A valve unit including a body; a first passage extending through the body, the first passage having an inlet opening and an outlet opening; a movable member rotatably provided in the first passage between the inlet opening and the outlet opening; a second passage extending through the movable member, the movable member being adapted to be rotatable within the first passage to selectively inversely align the second passage with the first passage; a control member movably located inside the second passage, the control member being adapted to regulate the filling of a first volume of flowable substance through the inlet opening into the second passage and, after rotation of the movable member to invert the second passage relative to the first passage, to regulate the exhaustion of the first volume of flowable substance from the second passage through the outlet opening, while simultaneously regulating the intake of a second volume of flowable substance through the inlet opening into the second passage; and a bypass passage in which no control member is provided being adapted to allow unrestricted and unmeasured exhaustion of the flowable substance to pass through the first passage.

10. A valve unit including a body; a first passage extending through the body, the first passage having an inlet opening and an outlet opening; a movable member rotatably provided in the first passage between the inlet opening and the outlet opening; a second passage extending through the movable member, the movable member being adapted to be rotatable within the first passage to selectively inversely align the second passage with the first passage; a control member movably located inside the second passage, the control member being adapted to regulate the filling of a first volume of flowable substance through the inlet opening into the second passage and, after rotation of the movable member to invert the second passage relative to the first passage, to regulate the exhaustion of the first volume of flowable substance from the second passage through the outlet opening, while simultaneously regulating the intake of a second volume of flowable substance through the inlet opening into the second passage; and a self-closing mechanism being adapted to cause the first and second passages to be unaligned when not in use.

11. A valve unit as claimed in claim 10, in which the self-closing mechanism is a spring loaded cam.

12. A valve unit as claimed in claim 10, which includes a counter for indicating a total number of dosages dispensed through the first passage.

13-16. (canceled)

17. A valve unit as claimed in claim 1, which includes a counter for indicating a total number of dosages dispensed through the first passage.

18. A valve unit as claimed in claim 2, which includes a counter for indicating a total number of dosages dispensed through the first passage.

19. A valve unit as claimed in claim 4, which includes a counter for indicating a total number of dosages dispensed through the first passage.

20. A valve unit as claimed in claim 5, which includes a counter for indicating a total number of dosages dispensed through the first passage.

21. A valve unit as claimed in claim 9, which includes a counter for indicating a total number of dosages dispensed through the first passage.
